(19) United States
(12) Patent Application Publication
(10) Pub. No.: US 2016/0033821 A1
(43) Pub. Date: Feb. 4, 2016

(54) DISPLAY DEVICE

(71) Applicant: CANON KABUSHIKI KAISHA, Tokyo (JP)

(72) Inventor: Shingo Yasuda, Hiratsuka-shi (JP)

(21) Appl. No.: 14/810,881

(22) Filed: Jul. 28, 2015

(30) Foreign Application Priority Data
Aug. 4, 2014 (JP) 2014-158851

(51) Int. Cl. G02F 1/1335; G02F 1/1333

(52) U.S. Cl. CPC G02F 1/133603; G02F 1/133308; G02F 1/133606; G02F 1/133345; G02F 1/133382; G02F 2001/133317

(57) ABSTRACT

a display device comprises a display panel; a light source member which is disposed on a rear surface side of the display panel and which has thereon a plurality of light source elements that irradiate light; a case member which is disposed on the rear surface side of the display panel and to which the light source member is attached; and a heat dissipation member which diffuses heat generated by the light source member, wherein the light source member is attached on an outer side of the case member, and is sandwiched between the case member and the heat dissipation member; and the case member has a fastening member that fastens the light source member and the heat dissipation member.

### BACKGROUND OF THE INVENTION

1. Field of the Invention

The present invention relates to a display device having a backlight light source.

2. Description of the Related Art

Transmission-type display devices, such as liquid crystal display devices, are provided with a backlight device that irradiates light from the rear surface of a panel. In recent years, backlight modules that utilize light-emitting diodes (LEDs) have come to be frequently used in television devices and business display devices. Device life can be prolonged, and recycling made easier, by using LEDs in the backlight.

The amount of heat generated by backlight modules has increased in recent years as a consequence of the higher brightness and wider dynamic range of display devices. Backlight modules may malfunction when the temperature of the module exceeds a design value, and hence heat dissipation in the module has become more important than ever before.

FIG. 7 is a cross-sectional diagram of a comprehensive view of a display device 700 in a conventional example. In the figure, the upward direction denotes the front surface side of the display device, and the downward direction denotes the rear surface side of the display device.

The reference symbol 701 is a display panel, and the reference symbol 702 is a light source board having a plurality of LED elements 702a mounted thereon. The light source board 702 is disposed on an inner bottom face section of a backlight case 703 having substantially a box shape and having side wall sections on four sides of the bottom face section. The light source board 702 is fastened, by a screw 707, to a fastening section 703a of the backlight case 703, in such a manner that a reflecting-diffusing sheet 704 is disposed on the side on which the LED elements 702a are mounted, and a heat-conducting sheet 705 having insulating properties is disposed on the rear surface side of the light source board 702.

The heat generated by the LED elements 702a diffuses towards the metallic backlight case 703, as denoted by arrow A. This suppresses as a result local rises in the temperature of the LED elements 702a.

The reference symbol 706 is a substrate (light source driving substrate) for light source driving. The light source board 702 and the light source driving substrate 706 are connected to each other via connectors 702b and 706a.

In a conventional display device, thus, the light source board is disposed at the inner bottom face section of a case, and a reflecting-diffusing sheet is disposed on the surface of the light source board, to achieve as a result both heat dissipation and light diffusion properties.

Japanese Patent No. 4968014 discloses a liquid crystal display device in which a light source board is pressed, by a reflecting-diffusing sheet, against a bottom chassis on the rear surface side, to enhance thermal conduction efficiency.

### SUMMARY OF THE INVENTION

As illustrated in the figure, the reflecting-diffusing sheet 704 in the conventional display device is provided with through-holes for exposing the light source elements 702a, and is disposed on the mounting side of the light source elements 702a, and inward of the side wall sections of the backlight case 703. A light diffusion space can be formed as a result that allows irradiating homogeneous light onto an optical sheet 708.

The light source board 702 may in some instances exhibit warping during use of the display device.

In the display device illustrated in FIG. 7, such warping is suppressed through pressing of the reflecting-diffusing sheet 704 against the light source board 702. However, the bottom face section, of the reflecting-diffusing sheet 704, that is in contact with the light source board 702 has substantially a flat plate shape, and thus suppression of warping of the light source board 702 through pressing against the latter is geometrically insufficient.

The reflecting-diffusing sheet 704 is made up mainly of foamed white PET having a thickness ranging from about 0.3 to 1 mm, and exhibits a bending stress smaller than that of glass epoxy substrates (about 1 mm thick) that are ordinarily used as the light source board 702. Therefore, suppression of initial warping of the light source board 702, and warping due to heat, is likewise insufficient from the viewpoint of the materials involved.

Such being the case, warping of the light source board 702 in conventional display devices is suppressed by increasing the number of fastening screws 707. In such a method, however, the substrate is fixed at given points, and, accordingly, warping at non-fastened portions cannot be suppressed. Further problems arose in that when warping occurs in the substrate, the thermal contact resistance between the heat dissipation member and the light source board increases, and, as a result, the heat dissipation efficiency of the light source board 702 drops, and the in-plane temperature becomes uneven.

In view of the above conventional problems, it is an object of the present invention to provide a technology for suppressing warping of a light source board in a display device, and efficiently dissipating generated heat.

The present invention in its one aspect provides a display device, comprises a display panel; a light source member which is disposed on a rear surface side of the display panel and which has thereon a plurality of light source elements that irradiate light; a case member which is disposed on the rear surface side of the display panel and to which the light source member is attached; and a heat dissipation member which diffuses heat generated by the light source member, wherein the light source member is attached on an outer side of the case member, and is sandwiched between the case member and the heat dissipation member; and the case member has a fastening member that fastens the light source member and the heat dissipation member.

The present invention allows suppressing warping of a light source board in a display device, and efficiently dissipating generated heat.

Further features of the present invention will become apparent from the following description of exemplary embodiments with reference to the attached drawings.

### BRIEF DESCRIPTION OF THE DRAWINGS

FIG. 1 is an X-Z cross-sectional diagram of a liquid crystal display device according to a first embodiment;

FIG. 2A is an enlarged-view diagram of section A of the liquid crystal display device according to the first embodiment;

FIG. 2B is an enlarged-view diagram of section B of the liquid crystal display device according to the first embodiment;

FIG. 2C is an enlarged-view diagram (variation) of section B of the liquid crystal display device according to the first embodiment;

FIG. 3 is a diagram for explaining a procedure for assembling the liquid crystal display device according to the first embodiment;

FIG. 4A is a diagram illustrating an example of a relationship between pressing pressure and a heat transfer coefficient of a heat dissipation member;

FIG. 4B is a diagram illustrating an enlarged portion of a heat sink;

FIG. 5 is an X-Z cross-sectional diagram of a liquid crystal display device according to a second embodiment;

FIG. 6 is an X-Z cross-sectional diagram of a liquid crystal display device according to a third embodiment; and

FIG. 7 is an X-Z cross-sectional diagram of a liquid crystal display device according to a conventional example.

### DESCRIPTION OF THE EMBODIMENTS

### First Embodiment

A liquid crystal display device according to a first embodiment of the present invention will be explained next with reference to accompanying drawings.

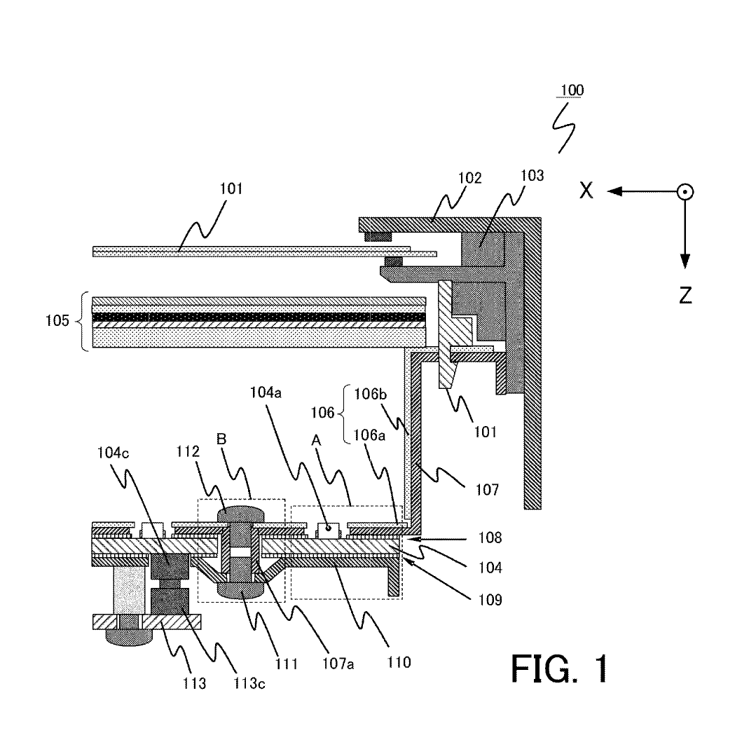

FIG. 1 is a cross-sectional diagram of a comprehensive view of a liquid crystal display device 100 according to the present embodiment. In the figure, the upward direction denotes the front surface side of the display device, and the downward direction denotes the rear surface side of the display device.

<Explanation of the Internal Structure>

The elements that make up the liquid crystal display device 100, and the arrangement of the elements, will be explained first.

A liquid crystal display panel (reference symbol 101) is a panel in which a pair of glass substrates, made up of a thin-film transistor substrate (TFT substrate) and a color filter substrate (CF substrate), is disposed such that the glass substrates oppose each other across a predetermined spacing, with a liquid crystal filled in between. The liquid crystal display panel 101 is pinched by a case frame 102, comprising a thin plate made of metal, and a panel holder 103, made of resin, in such a manner that no local stress acts on the liquid crystal display panel 101.

An optical sheet 105 for uniformizing light that is irradiated by a backlight and for enhancing front brightness is disposed on the rear surface side of the liquid crystal display panel 101. The reflecting-diffusing sheet 106, being a reflecting-diffusing member, is a sheet for reflecting and diffusing light, and is bonded or fastened along the inner face of a backlight case 107, being a case member.

A surface light source of uniform brightness and chromaticity can be thus be provided in which a light diffusion space is formed by the optical sheet 105 that is disposed on the rear surface side of the display panel 101, and by the reflecting-diffusing sheet 106 has disposed along the inner face of the backlight case 107.

The reflecting-diffusing sheet 106 comprises a flat plate-like base section 106a provided with through-holes for exposing light source elements, and a side wall section 106b that covers a side wall face (and peripheral edge of the optical sheet 105) of the backlight case 107. The reflecting-diffusing sheet 106 may be produced integrally, through folding, but has preferably a configuration made up of the base section 106a and a plurality of side wall sections 106b, as illustrated in FIG. 1. The material of the reflecting-diffusing sheet 106 is mainly foamed white PET, as described above, which contracts by about several percent under the influence of heat. A configuration wherein the reflecting-diffusing sheet 106 is made up of a plurality of members makes it possible to suppress rise that occurs at a bending boundary between the base section and the side wall section, and makes it possible to suppress deflection and gaps on the internal face of the backlight case 107, caused by punching and/or bending errors.

The light source board 104 is a substrate (light source member) on which there are disposed, substantially in a planar manner, a plurality of light source elements 104a serving as a backlight light source that illuminates the liquid crystal display panel 101. The light source board 104, the material whereof is polyethylene terephthalate (PET) or polycarbonate (PC), is disposed outside the backlight case 107, across a sheet member having insulating properties (insulating sheet 108) and having a thickness in the range from about 0.1 to 0.3 mm.

Through-holes for exposing the light source elements 104a are provided in the backlight case 107 and the insulating sheet 108. An insulating sheet 109 and a heat sink 110 are further disposed on the rear surface side of the light source board 104. The heat sink 110 is disposed so as to press against the light source board 104, by virtue of a screw 111. The light source board 104 is mutually connected to a driving circuit board 113 by way of inter-board connectors 104c and 113c.

In the structure of the present embodiment, thus, the light source board 104 is disposed outside the backlight case 107, and is sandwiched between mutually opposing surfaces of the backlight case 107 and the heat sink 110.

The opposing surfaces of the backlight case 107 and the heat sink 110 need not be perfectly parallel. For instance, the opposing surface of the backlight case 107 may have a slightly protruded shape in the outward direction of the box shape, i.e. towards the light source board 104, and likewise the opposing surface of the heat sink 110 may have a slightly protruded shape towards the light source board 104. Adhesiveness of the surfaces to each other can be further enhanced by resorting to such shapes. In a case where, for instance, the size of the liquid crystal display panel ranges from about 20 to 30 inches, adhesiveness with the light source board 104 can be increased, without solder joints of a wiring pattern and/or mounted components of the light source board 104 being subjected to stress at or above tolerances, if the degree of protrusion lies within a range of about 1 mm.

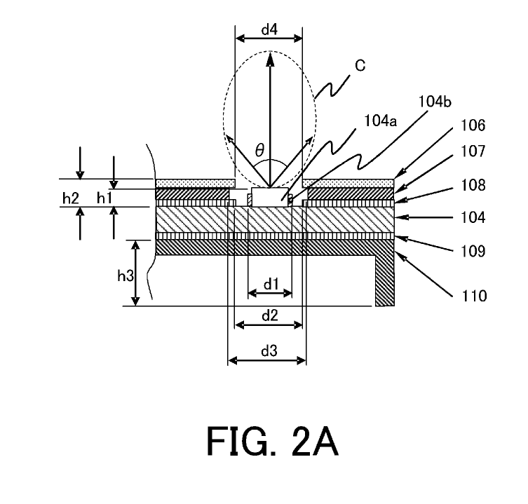

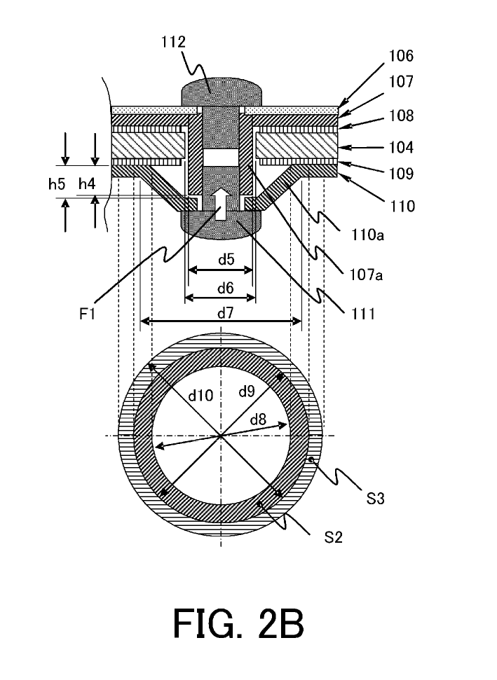

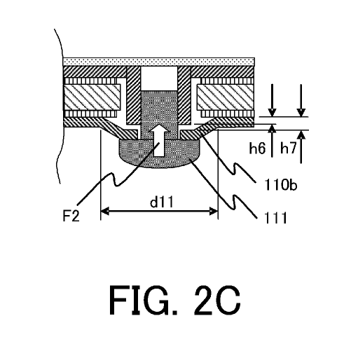

The structure of section A and section B in FIG. 1 will be explained next with reference to FIG. 2A to FIG. 2C. FIG. 2A is an enlarged-view diagram of section A in FIG. 1, and FIG. 2B is an enlarged-view diagram of section B in FIG. 1. FIG. 2C is a variation of section B.

Section A will be explained first with reference to FIG. 2A.

The light source element 104a in FIG. 2A is a light-emitting diode (LED) of substantially rectangular parallelepiped shape. As an example, the light source element 104a takes on a shape having a length (d1) of one side of 3 mm and a height (h1) of 1 mm. In the present embodiment, the reflecting-diffusing sheet 106, the backlight case 107, the insulating sheet 108, the light source board 104, the insulating sheet 109 and the heat sink 110 are stacked in this order from the display panel 101 side (from the top, illustrated in the figure). The thickness of the reflecting-diffusing sheet 106 ranges from about 0.3 to 1 mm. The backlight case 107 is made up of a stainless steel member (SUS304, SUS430 or the like), or of sheet metal (SECC, SPCC) having a thickness of about 0.5 mm. The thickness of the insulating sheet 108 ranges from about 0.1 to 0.3 mm. The thickness of the light source board 104 ranges from about 0.5 to 1.2 mm. The thickness of the insulating sheet 109 ranges from about 0.1 to 0.3 mm. The heat sink 110 is made up of an aluminum member (A5052 or the like) having a thickness ranging from about 1 to 3 mm.

Anode and a cathode electrode sections 104b are respectively provided on both sides of the light source element 104a; accordingly, it is important to secure insulation with the end faces of a square hole (square hole dimension: d3) of the metallic backlight case 107. Preferably, therefore, the square hole dimension (d3) of the backlight case 107 is set to be greater than the dimension (d1) of one side of the light source element 104a, including the electrode sections 104b. The value of d3 amounts to about 7 mm when the dimension of the gap, on one side, is secured to be of about 2 mm.

In a case where the backlight case 107 is a stainless steel member, it becomes possible to prevent electrical short-circuits with the electrode sections 104b, due to rust or the like, by forming a chemically stable thin oxide film (passivation film) onto the end faces of the square hole. In a case where the material of the backlight case 107 is sheet metal, for instance an electro-galvanized steel sheet (SECC), electrical short-circuits can be prevented by subjecting at least the end faces of the square hole to an anti-rusting treatment by coating. Herein there may be used a coating material having a light diffusing-reflecting function, and comprising a white pigment the main component whereof is titanium oxide, or containing very fine air bubbles. Such a coating material allows reducing production costs, as a substitute for the reflecting-diffusing sheet 106.

The reflecting-diffusing sheet 106 is configured in such a manner that the light emitted by the light source element 104a is diffused and reflected efficiently, but this does not imply that all light is reflected, without any leaks. Specifically, some of the light passing through the reflecting-diffusing sheet 106 may be lost through absorption by the light source board and/or the surface of the backlight case. Therefore, a BA (bright annealed) material having been subjected to a thermal treatment in a special gas atmosphere, after being cold-rolled, may be used as the stainless steel member of the backlight case 107. The surface of the BA material is worked to a mirror finish, so that some of the light that passes through the reflecting-diffusing sheet 106 can be accordingly re-used.

The square hole for exposing the light source element 104a must be of appropriate dimensions in order to protect the light source board 104 against punching burr at the end faces of the square hole of the backlight case 107.

Preferably, dl being the dimension of one side the light source element 104a including the electrode sections 104b, d2 being the square hole dimension of the insulating sheet 108, and d3 being the square hole dimension of the backlight case 107, are set such that:

d1<d2<d3 Expression (1)

For instance, it suffices to set about d2=5 mm in a case where d1=3 mm and d3=7 mm.

A dashed line C denotes herein a light distribution curve, having a half-value angle θ for which the relative intensity of light is 0.5, at a time where the maximum brightness value directly above the light source of the light source element 104a of FIG. 2A being set to 1. In this case, preferably, a square hole dimension (d4) of the reflecting-diffusing sheet 106 is a dimension that does not interfere with the dashed line C.

When a value (h2) resulting from adding the thicknesses of the reflecting-diffusing sheet 106, the backlight case 107 and the insulating sheet 108 is greater than the height (h1) of the light source element 104a, a concern arises that light of the light source may be blocked, depending on the dimension of d4, and, accordingly, the value of d4 as well must be increased. The value of d4 should be made as small as possible in terms of enhancing the utilization efficiency of the light source. To accommodate both requirements, materials having a requisite minimum thickness may be used in the reflecting-diffusing sheet 106, the backlight case 107 and the insulating sheet 108. As an example, substituting the respective values in the expression yields a value substantially comparable to that of h1=1 mm, according to Expression (2).

h2=0.5+0.5+0.1=1.1 mm Expression (2)

Therefore, Expression (2) can be combined with Expression (1) to give Expression (3).

d4≅d2 Expression (3)

Section B will be explained next with reference to FIG. 2B.

The backlight case 107, the light source board 104 and the heat sink 110 are fastened in the present embodiment using a caulking member 107a and a screw 111, being fastening members.

Positioning of the light source board 104 and the backlight case 107, in the surface direction, will be explained first. The outer diameter φ of the caulking member 107a, which is press-indented into the backlight case 107 and which results from tapping of the inner face of a cylindrical through-hole that having been, is defined as d5 (mm), and the outline φ of the through-round hole of the light source board 104 is defined as d6 (mm).

For instance, positioning can be accomplished easily, without interference with d1 for the through-hole d3 of the backlight case 107, by producing section B with a tapping thread diameter: M3, d5=φ6.2(+0.08/0) mm, d6=φ6.3(+0.1/0) mm.

A heat dissipation structure achieved through contact between the light source board 104 and the heat sink 110 will be explained next. In FIG. 2B, the thickness of the reflecting-diffusing sheet 106 is set to 0.5 mm, the thickness of the backlight case 107 is set to 0.5 mm, the thickness of the insulating sheets 108 and 109 is set to 0.1 mm, the thickness of the light source board 104 is set to 1.0 mm, and the thickness of the heat sink 110 is set to 1.5 mm.

That is, the total value of the thickness of the backlight case 107, the insulating sheet 108, the light source board 104, the insulating sheet 109 and the heat sink 110, in this order from the display panel 101, is 3.2 mm. A protrusion amount h4 on the rear surface side, from the insulating sheet 109, takes on a value given by Expression (4), with the total length of the caulking member 107a being set to 7 mm.

h4=7−3.2=3.8 mm Expression (4)

A pressing section 110a of the heat sink 110 of FIG. 2B is formed mainly through press-working of sheet metal. As an example, if a pressing amount (h5) is set to about 4.0 mm, then a clearance given by Expression (5), on the basis of the value of 3.8 mm obtained from Expression (4), becomes formed between the caulking member 107a and the pressing section 110a.

h5−h4=0.2 mm Expression (5)

A configuration is also possible in which heat dissipation takes place through pressing of the heat sink 110 against the light source board 104, which is a heat source, when screw fastening is performed up to h4≅h5, depending on an axial force F1 (N) by the fastening torque of the screw 111, and the elastic deformation of the backlight case 107 and the heat sink 110.

<Comparison of Stress Concentration>

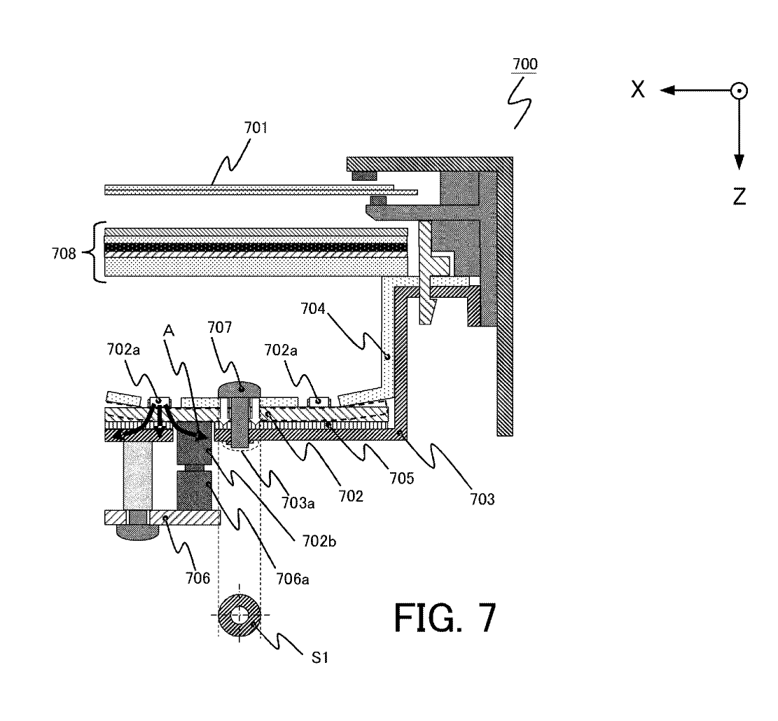

A comparison of stress concentration according to the contact surface area of the light source board 104 and the heat sink 110 will be explained next with reference to FIG. 7 and FIG. 2B. In the example of FIG. 7, the light source board 702 is pressed against the backlight case 703, across the reflecting-diffusing sheet 704, using an M3 pan head screw as the screw 707. Expression (6) below is obtained where S1 is the contact surface area, the screw head diameter of the screw 707 is set to 5.5 mm, and the through-hole diameter of the light source board 702 set to 3.5 mm.

S1=π(5.5/2)²−π(5.5/2)²=4.5π (mm²) Expression (6)

As an example, a contact pressure P1 is given by Expression (7) below by substituting an axial force F1=525 (N).

P1=525/4.5π≅37.1 (N/mm²) Expression (7)

In the structure of FIG. 2B, the light source board 104 is in thermal contact with the heat sink 110 via the insulating sheet 109. The contact pressure decreases stepwise, in the order shaded portion S2 and shaded portion S3, at concentric circles from the center of the pressing section 110a of the heat sink 110. Assuming all of the axial force F1 (N) is applied in the shaded portion S2, there holds

S2=π(d9/2)²−π(d8/2)²

As an example, Expression (8) below is obtained by substituting d9=19.5 mm and d8=16.5 mm.

S2=π(19.5/2)²−π(16.5/2)²=27π (mm²) Expression (8)

As a further example, a contact pressure P2 is given by Expression (9) below by substituting an axial force F1=525 (N).

P2=525/27π≅6.2 (N/mm²) Expression (9)

The above results reveal that stress concentration can be suppressed to about one sixth, in a comparison between the conventional example of FIG. 7 and the example of FIG. 2B. The example of FIG. 2B constitutes thus a preferred structure from the viewpoint of preventing deformation of the light source board and eliciting thermal homogeneity.

FIG. 2C is a variation of FIG. 2B. In the example of FIG. 2B, the screw 112 was fastened in order to fix the reflecting-diffusing sheet 106 to the substantially box-shaped internal face of the backlight case 107. In terms of reducing member costs and assembly steps, however, such fixing may be accomplished not using screws, but using a bonding member such as a heat-resistant double-sided tape or the like. This allows dispensing with the through-hole that is provided in the reflecting-diffusing sheet 106 in order to insert the screw.

<Procedure for Assembling a Liquid Crystal Display Device>

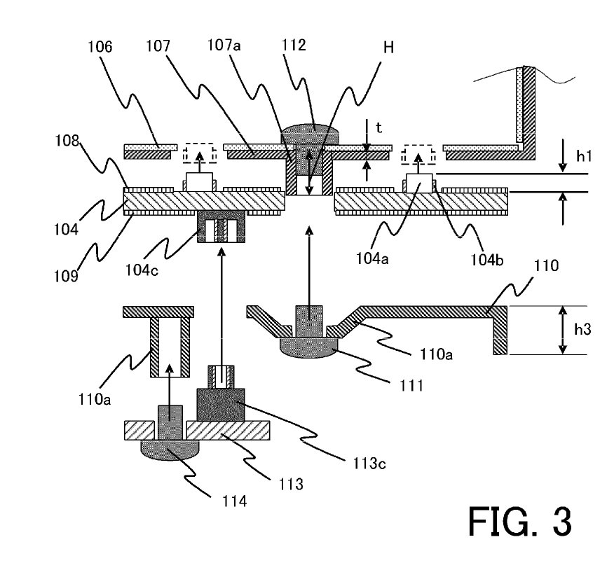

A procedure for assembling the liquid crystal display device 100 according to the first embodiment will be explained next with reference to FIG. 3. Firstly, the reflecting-diffusing sheet 106 is fixed to the backlight case 107 using a double-sided tape (not shown), or the screw 112. Next, the light source board 104 is inserted (fitted), from outside the backlight case 107, using, for positioning, the cylindrical protruded portion of the caulking member 107a.

In the present example, a value (H−t) resulting from subtracting the plate thickness t of the backlight case 107 from the total length H of the caulking member 107a is set to be sufficiently larger than a mounting height (h1) of the light source elements 104a. As a result, the light source elements 104a and the electrode sections 104b do not interfere with the end faces of the through-hole of the backlight case 107, and, accordingly, the foregoing can be assembled reliably.

As an example, H−t=6.5 mm>>h1=1 mm holds when setting H=7 mm, t=0.5 mm and h1=1 mm.

Next, the heat sink 110 is fastened, using the screw 111, to the caulking member 107a of the backlight case 107, from the rear surface side of the light source board 104. Lastly, an inter-board connector 113c of the driving circuit board 113 is inserted into an inter-board connector 104c that is mounted on the rear surface side of the light source board 104, and the whole is fastened using a screw 114.

<Temperature Distribution Homogenization>

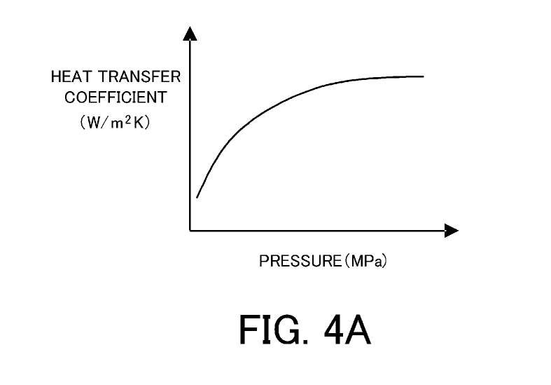

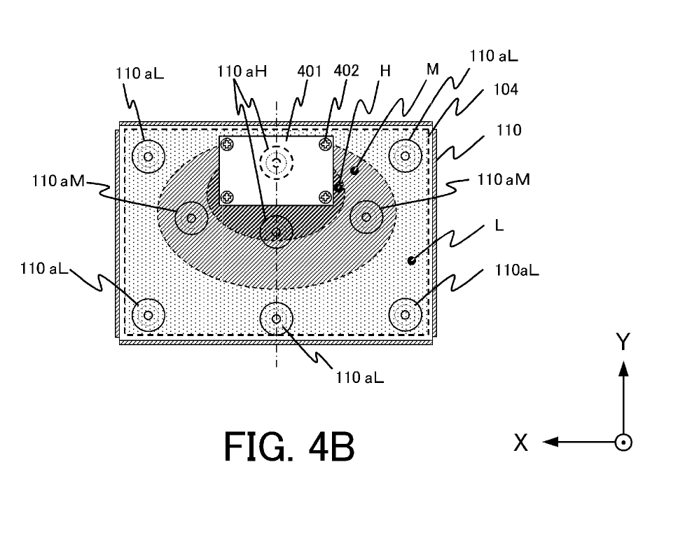

An explanation follows next, with reference to FIG. 4A and FIG. 4B, on homogenization of the in-plane temperature distribution of the light source board 104.

White LED elements or LED elements being a combination of a plurality of red, green and blue colors are used as the light source elements 104a of the light source board 104. The light source device that is used in the liquid crystal display device is required to emit a uniform amount of light in the plane. On the other hand, the brightness and chromaticity of LED elements vary with temperature. Uniformizing the in-plane temperature distribution of the light source board 104 is accordingly an important issue in terms of enhancing the display performance of the liquid crystal display device.

FIG. 4A is a diagram illustrating an example of the relationship between the pressing pressure and the heat transfer coefficient of a heat dissipation member, during dissipation of heat generated by the heat source, using the heat dissipation member. As FIG. 4A illustrates, increasing the pressing pressure of the heat dissipation member on the heat source translates into a likewise higher heat transfer coefficient.

FIG. 4B is a diagram illustrating an observation of part of the heat sink 110 of the liquid crystal display device 100, from the rear surface direction (Z-axis direction) of the device. There are nine pressing sections 110a on the plane of the heat sink 110. A control circuit board 401 that controls the liquid crystal display panel 101 is fastened using four screws 402. The dotted-line rectangle denotes the position of the light source board 104.

The in-plane temperature distribution of the light source board 104 is represented in FIG. 4B by the characters L, M and H. Specifically, region L at the outermost peripheral edge is a region of relatively lowest temperature, and region H is a region of highest temperature (region M denotes intermediate temperature). Reasons that underlie such a temperature distribution include, for instance, rising convection, inside the display device, of air that is warmed up by the light source elements 104a, as heat sources, as well as the fact that the control circuit board 401, having heat-generating elements mounted thereon, is stacked on the rear surface of the heat sink 110.

Methods for uniformizing the in-plane temperature distribution of the light source board 104 include, for instance, a method that involves modifying the arrangement density of the nine pressing sections 110a (110aL, 110aM, 110aH). For instance, the in-plane temperature distribution can be made uniform by setting the arrangement density of the pressing sections to be higher the higher the temperature of the region is, and to be lower the lower the temperature of the region is.

The pressing pressure (fastening force) of the heat sink 110 on the light source board 104 may be set to be greater the higher the temperature of the region is, and to be smaller the lower the temperature of the region is. For instance, the pressing height of the pressing sections 110a may be set so as to satisfy Expressions (10) to (12), focusing on the clearance value h5-h4 in FIG. 2B.

For the pressing section 110aH (high-temperature section), there holds

h5−h4=0.3 (mm) Expression (10),

for the pressing section 110aM (intermediate temperature section),

h5−h4=0.2 (mm) Expression (11),

and for the pressing section 110aL (low-temperature section),

h5−h4=0.1 (mm) Expression (12).

As a result, the axial force F1 (N), i.e. the pressing pressure of the heat sink 110 on the light source board 104 can be made larger the higher the temperature of the region is, and smaller the lower the temperature of the region is. That is, the in-plane temperature distribution of the light source board 104 can be made uniform as a result.

<Magnitude Relation of Flexural Stiffness>

A relationship between the magnitudes of flexural stiffness of the backlight case 107, the light source board 104 and the heat sink 110 will be explained next with reference to FIG. 3 and FIG. 4B.

The heat sink 110 in FIG. 4B is a rectangular flat plate, with the four sides on the peripheral edge bent towards the rear surface, to secure flexural stiffness. This bent portion, which corresponds to the portion of height h3 in FIG. 3, has a width ranging from about 5 to 10 mm.

The flexural stiffness of the heat sink 110 is proportional to the cube of the bending height h3, and hence the flexural stiffness can be increased easily. Bending work is performed towards the rear surface of the light source board 104, and hence such bending has few spatial constraints. That is, the flexural stiffness of the heat sink 110 can be made greater than that of the backlight case 107 or the light source board 104. Even if the light source board 104 warps, the large flexural stiffness of the heat sink 110 allows the latter to re-flatten the light source board 104. A stable heat dissipation structure can be thus achieved.

In the present embodiment, the insulating sheets 108 and 109 are provided on both faces of the light source board 104, but the insulating sheets are not a necessary requirement, if the surface of the light source board 104 is electrically insulated.

### Second Embodiment

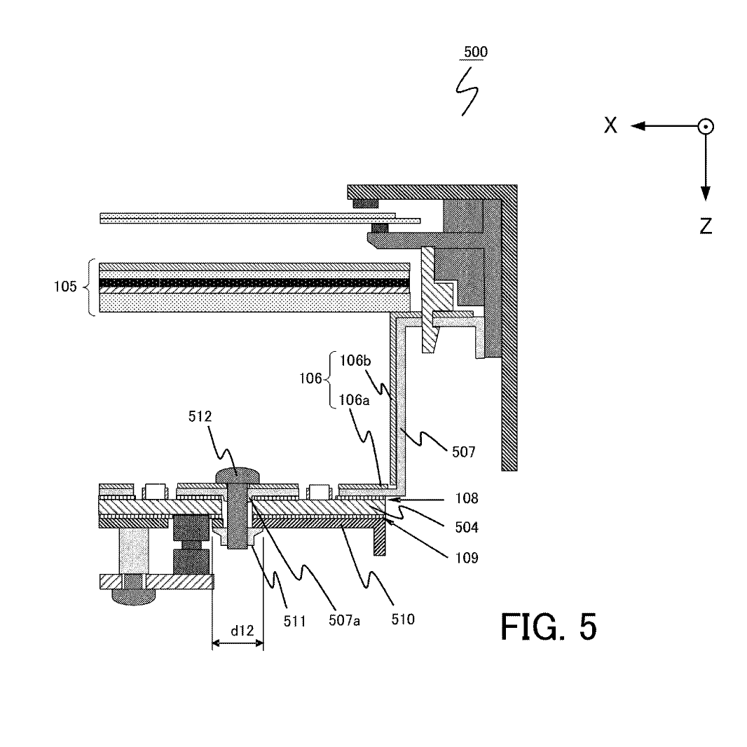

A second embodiment will be explained next with reference to FIG. 5. The second embodiment is an embodiment in which a protruding burring tap section 507a is provided instead of the caulking member 107a of the first embodiment. The explanation of the present embodiment will focus mainly on differences with respect to the first embodiment, while features identical to those of the first embodiment will not be explained.

In the second embodiment, a burring tap section 507a having a shape protruding towards a light source board 504 is provided, instead of the caulking member 107a of the backlight case 107 of FIG. 1, at the bottom face section of a backlight case 507. A screw 512 that runs through a through-hole of the insulating sheet 108, the light source board 504, the insulating sheet 109 and a heat sink 510 is fastened using the burring tap section 507a, to fix the base section 106a of the reflecting-diffusing sheet 106.

In the second embodiment, the light source board 504 is sandwiched between the backlight case 507 and the heat sink 510 through fastening of a flange nut 511 (for instance, M3, outer diameter d12=8 mm) on the side of the leading end section of the screw 512 that protrudes from the heat sink 510.

In the second embodiment, it suffices to fasten the heat sink 510 with the flange nut 511, using the screw 512 having a length such that the latter protrudes from the heat sink 510. Accordingly, it is no longer necessary to provide a shape such as the one of the pressing section 110a of FIG. 2B. The working costs of parts can be kept low as a result.

### Third Embodiment

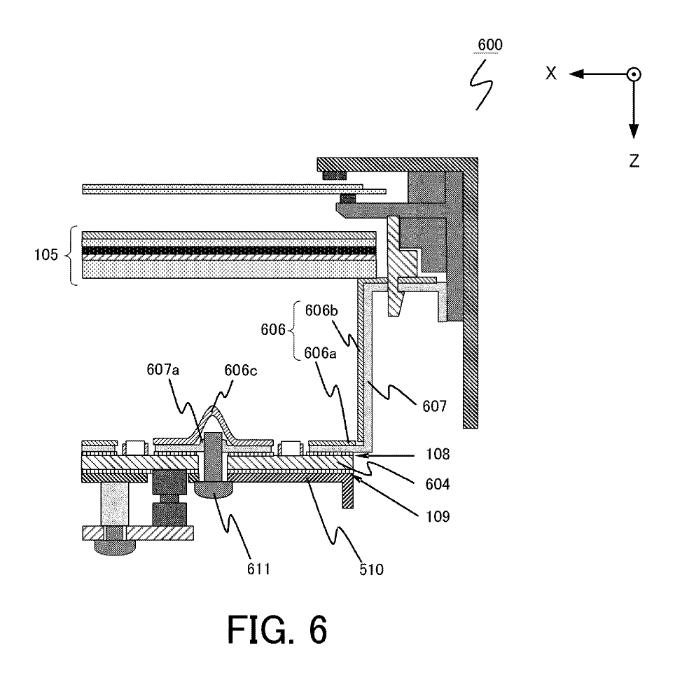

A third embodiment will be explained next with reference to FIG. 6. The third embodiment is similar to the second embodiment, but differs from the latter as regards the direction of the protruded shape of the burring tap section. The explanation of the present embodiment will focus mainly on differences with respect to the second embodiment, and features identical to those of the first embodiment will not be explained.

In the third embodiment, a burring tap section 607a having a protruded shape towards the display panel is provided in the bottom face section of a backlight case 607. A protruded shape (not shown) for positioning a light source board 604 is separately provided on the bottom face section of the backlight case 607.

The procedure for fastening the light source board 604 to the backlight case 607 is as follows. Firstly, the insulating sheet 108, the light source board 604, the insulating sheet 109 and the heat sink 510, stacked in this order from outside the substantially box shaped backlight case 607, are fixed by being fastened, using a screw 611, to the burring tap section 607a. The leading end section of the screw 611 protrudes by about 2 mm inward of the box shape of the backlight case 607; accordingly, an embossed section 606c is provided, in a reflecting-diffusing sheet base section 606a, at a site corresponding to the leading end protrusion of the screw 611. The leading end section of the protruding screw 611 can be covered as a result. The height of the embossed section 606c is set herein to be sufficiently low such that the influence of the embossed section 606c on an in-plane optical distribution is negligible.

The embossed section 606c can be produced in accordance with, for instance, a vacuum forming method in which a reflecting-diffusing sheet material is heated and thereafter placed on a conical recessed die, followed by evacuation, or a press-forming method in which a reflecting-diffusing sheet material is shaped by being pinched between a conical recessed die and a conical protruding die. The reflecting-diffusing sheet 606 is fixed to the box shape internal face of the backlight case 607 by way of a double-sided tape (not shown) or the like.

In the third embodiment, shavings of the burring tap section 607a do not intrude, during fastening of the screw 611, into the light diffusion space that is formed by the backlight case 607, the reflecting-diffusing sheet 606 and the optical sheet 105. Image display reliability can thus be secured.

(Variation)

The present invention has been explained by way of the illustrative embodiments explained above. The present invention can be realized in the form of appropriate modifications and combinations of the embodiments, without departing from the purport of the invention.

For instance, the present invention can be realized in the form of a display device that includes at least some of the above processes. The present invention can also be realized in the form of a control method of a display device including at least some of the above processes. These processes and means can be implemented by being freely combined with one another, so long as no technical inconsistencies arise in doing so.

In the explanation of the embodiments, for instance, a through-hole is provided in the backlight case 107 and the insulating sheet 108, and the light source elements 104a are exposed. Instead of exposing the light source elements, however, there may be used a light-transmitting member.

In the embodiments, examples have been explained of a liquid crystal display device that has a liquid crystal panel, but the present invention can also be used in display devices having organic EL displays, and in display devices having other kinds of display. The display devices in which the invention can be used may be of any type, so long as a display panel of the display device is illuminated by a backlight.

### Other Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-158851, filed on Aug. 4, 2014, which is hereby incorporated by reference herein in its entirety.

What is claimed is:

1. A display device, comprising:
a display panel;
a light source member which is disposed on a rear surface side of the display panel and which has thereon a plurality of light source elements that irradiate light;
a case member which is disposed on the rear surface side of the display panel and to which the light source member is attached; and
a heat dissipation member which diffuses heat generated by the light source member, wherein
the light source member is attached on an outer side of the case member, and is sandwiched between the case member and the heat dissipation member; and
the case member has a fastening member that fastens the light source member and the heat dissipation member.

2. The display device according to claim 1, wherein the case member forms a light diffusion space on a rear surface side of the display panel and has respective through-holes from which the light source elements are exposed to an inside of the light diffusion space.

3. The display device according to claim 1, wherein a sheet member having insulating properties is disposed on at least one of a face at which the case member and the light source member are in contact with each other and a face at which the light source member and the heat dissipation member are in contact with each other.

4. The display device according to claim 1, wherein flexural stiffness of the heat dissipation member is largest from among those of the respective opposing faces of the case member, the light source member and the heat dissipation member.

5. The display device according to claim 1, wherein
the fastening member has a protruded shape that protrudes towards the light source member; and
the light source member has a second through-hole that mates with the protruded shape.

6. The display device according to claim 5, wherein the height of the protruded shape of the fastening member is greater than a mounting height of the light source elements in the light source member.

7. The display device according to claim 1, wherein a reflecting-diffusing member that reflects or diffuses light is disposed at least in part of the interior of the case member.

8. The display device according to claim 7, wherein the reflecting-diffusing member results from subjecting at least part of the case member to a mirror finish.

9. The display device according to claim 1, wherein within a plane at which the light source member and the heat dissipation member are in contact with each other, the higher the temperature of a site of the light source member is, the greater is a fastening force with which the light source member and the heat dissipation member are fastened at that site.

10. The display device according to claim 1, wherein within a plane at which the light source member and the heat dissipation member are in contact with each other, the higher the temperature of a site of the light source member is, the higher is a density of arrangement at which the fastening member is disposed at that site.

11. The display device according to claim 1, wherein the display panel is a liquid crystal panel.
